(19) United States
(12) Patent Application Publication
(10) Pub. No.: US 2017/0306597 A1
(43) Pub. Date: Oct. 26, 2017

(54) WASHER WITH AN ADJUSTABLE INLET APERTURE FOR DIFFERENT WATER PRESSURE

(71) Applicant: Gary Wu, Homei Township (TW)

(72) Inventor: Gary Wu, Homei Township (TW)

(21) Appl. No.: 15/139,247

(22) Filed: Apr. 26, 2016

(51) Int. Cl. E03C 1/084; B05B 15/06; E03C 1/02; B05B 1/18

(52) U.S. Cl. CPC E03C 1/084; E03C 1/025; B05B 1/185; B05B 15/061; E03C 2001/026

(57) ABSTRACT

The water washer is made of an elastic rubber material and has a circular flat shape with a flange on its circumference; a flow adjustable portion has a flow adjustable portion with an inner curved face and an outer curved face; an adjustable inlet aperture is disposed through the inner curved face and the outer curved face of the flow adjustable portion; by deforming the inner curved face and the outer curved face of the flow adjustable portion to shirk the adjustable inlet aperture of the water saving washer.

### BACKGROUND OF THE INVENTION

### 1. Field of the Invention

The present invention relates to a washer, and more particularly to a showerhead washer with an adjustable inlet aperture for different water pressure

### 2. Description of the Related Art

Currently, according to the California Energy Commission's new Saving Act (California new water limiting regulations), all current faucet devices need to reduce water consumption. The goal is in the first yea, it is expected to save 10.3 billion gallons of water. For example: (1) The flow rate of faucets in each household bathroom should not exceed 1.2 gallons per minute. The flow rate in the previous provision is 2.2 gallons. (2) The flow rate of faucets in public bathrooms can not exceed 0.5 gallons per minute. (3) The flow rate of faucets in kitchens must be less than 1.8-2.2 gallons per minute. A conventional water-saving device (aerator) 50, as shown in FIG. 11, is connected to a faucet 40 via an outlet pipe 41. The aerator 50 comprises a housing 51, a aerator member 52, a diverter plate 53 and a throttle piece 54, and a leakproof gasket 55 is sandwiched between the aerator 40 and the outlet pipe 41. Therefore, water flows through the adjustable inlet apertures 541 of the throttle sheet 54, the diverter plate 53 and the aerator member 52. However, the throttle piece 54 is a rigid plate, and the adjustable inlet aperture requires water flow higher than the water amount limit of the new regulations of California water restrictions. In order to satisfy the new regulations, the replacement of whole faucet line is not cost-effective, and will significantly reduce the implement of the new regulations.

On the other hand, a conventional showerhead structure, as shown in FIG. 12. The showerhead 60 utilizes a tubular body 61 to connect to a water outlet head 62, and a washer 63 is provided between the tubular body 61 and the head 62. The head 62 has a plurality of sprinkle holes 621. While the conventional showerhead 60 is designed to have water saving effect, the throttling piece 64 is provided between the tubular body 61 and the head 62. Since the aperture of throttling piece 64 is not adjustable, thus increasing the pressure will increase the amount of water flowing. In order to improve water saving effect, the whole of the head 62 will have to be replaced, which is not cost-effective. However, if by only replacing the washer 63 can make showerhead 60 has the water-saving effect, which will be able to effectively reduce replacement cost.

Therefore, it is desirable to provide a washer with an adjustable inlet aperture for different water pressure to mitigate and/or obviate the aforementioned problems.

### SUMMARY OF THE INVENTION

An objective of the present invention is to provide a washer with an adjustable inlet aperture for different water pressure.

In order to achieve the above mentioned objective, the water saving washer is made of an elastic rubber material and has a circular flat shape with a flange on its circumference; a flow adjustable portion has a flow adjustable portion with an inner curved face and an outer curved face; an adjustable inlet aperture is disposed through the inner curved face and the outer curved face of the flow adjustable portion; by deforming the inner curved face and the outer curved face of the flow adjustable portion to shirk the adjustable inlet aperture of the water saving washer; a base having a though hole disposed at a center position and a supporting ring disposed around the through hole, a bottom face formed outside of the supporting ring and an outer ring disposed at an outer edge of the bottom face; and a cover having a through aperture disposed at a center position, a positioning ring and a compressing loop coaxially and sequentially disposed around the through aperture, the cover engaging with the base to sandwich the water saving washer, the positioning ring of the cover pressing against the flange of the water saving washer, and the compressing loop pressing against the outer ring.

The water saving washer is provide with a supporting aperture between the inner curved face and the flange, the supporting aperture connects to the adjustable inlet aperture; the supporting aperture supports and controls the flow adjustable portion, and also prevents the flow adjustable portion from flipping around.

The water saving washer is configured for an aerator, the aerator comprises a cover, an aerator member, a filling member and a restricting member, the aerator member, the filling member and the restricting member are placed in the cover, and the water saving washer pushes against the restricting member.

The restricting member further has a limiting aperture corresponding to the adjustable inlet aperture of the water saving washer, and the filling member is connected to the limiting aperture and has a plurality of filling apertures; the aerator member has a plurality of mesh members, a space is formed between the mesh member and the filling member, and the aerator member further has a plurality of air apertures around the space.

An inner thread section is provided on the cover, the inner thread section engages with the outlet pipe of the faucet, and the base and cover are sandwiched between the aerator and the outlet pipe.

The water saving washer is configured for a shower head, the shower head comprises a outlet head, a universal joint and an outlet pipe; the outlet head has a plurality of sprinkle apertures; the universal joint is connected to another end of the outlet head and has a water channel connected to the sprinkle apertures; the universal joint is further provided with an inner threaded portion locked with the outlet pipe, and the base and cover are s sandwiched between the universal joint and the outlet pipe.

The flow adjustable portion of the water saving washer faces the outlet pipe, a surface of the cover is provided with a securing plate having a flowing aperture, and the flowing aperture is connected to the adjustable inlet aperture of the water saving washer.

The base and the outlet head are integratedly formed together, and the water saving washer and the cover are sequentially placed in the outer head and secured onto the base.

An inner engaging part is provided in the outer ring of the base, an outer engaging part is provided on the positioning ring of the cover, and the inner engaging part and the outer engaging part engages with each other.

A first benefit of the present invention is, the adjustable inlet aperture of the water saving washer produces throttling effect to control the amount of water. When the water pressure is increased, the water pressure generates a pushing force onto the water saving washer. Meanwhile, the flow adjustable portion of the water saving washer is suffered from elastic deformation, the inner curved face and the outer curved face of the flow adjustable portion control the amount of compression deformation. When the water pressure is high, the flow adjustable portion recesses in a larger magnitude which narrows the adjustable inlet aperture. Therefore, under high water pressure, the water saving washer stabilizes the elastic deformation of narrowing the adjustable inlet aperture, such that the water flow is not affected by water pressure.

Another benefit of the present invention is, with the outer ring of the base and the compressing loop of the cover, the water saving washer will not be deformed during the assembly. Furthermore, the supporting ring of the base presses against the inner curved face of the washer.

Another benefit of the present invention is, the base and the cover are sandwiched between the aerator and the outlet pipe or between the shower head and the outlet pipe. Therefore, the water saving washer can be combine with the current aerator or the current shower head to satisfy the new regulations without the need of using a another sealing ring or changing to a new aerator or a new shower head.

Other objects, advantages, and novel features of the invention will become more apparent from the following detailed description when taken in conjunction with the accompanying drawings.

### BRIEF DESCRIPTION OF THE DRAWINGS

FIG. 1 is a perspective drawing of an embodiment of the present invention.

FIG. 2 is a perspective drawing of the embodiment of the present invention.

FIG. 3 is a cross-sectional view of the embodiment of the present invention.

FIG. 4 is a schematic drawing of the usage of the embodiment of the present invention.

FIG. 5 is a schematic drawing of the usage of another embodiment of the present invention.

FIG. 6 is a schematic drawing of the usage of the embodiment of the present invention.

FIG. 7 is a schematic drawing of the usage of another embodiment of the present invention.

FIG. 8 is another schematic drawing of the usage of the embodiment of the present invention.

FIG. 9 is a cross-sectional view of another embodiment of the present invention.

FIG. 10 is a local-detailed drawing of another embodiment of the present invention.

FIG. 11 is a cross-sectional view of a prior art aerator.

FIG. 12 is a cross-sectional view of a prior art showerhead.

### DETAILED DESCRIPTION OF THE PREFERRED EMBODIMENT

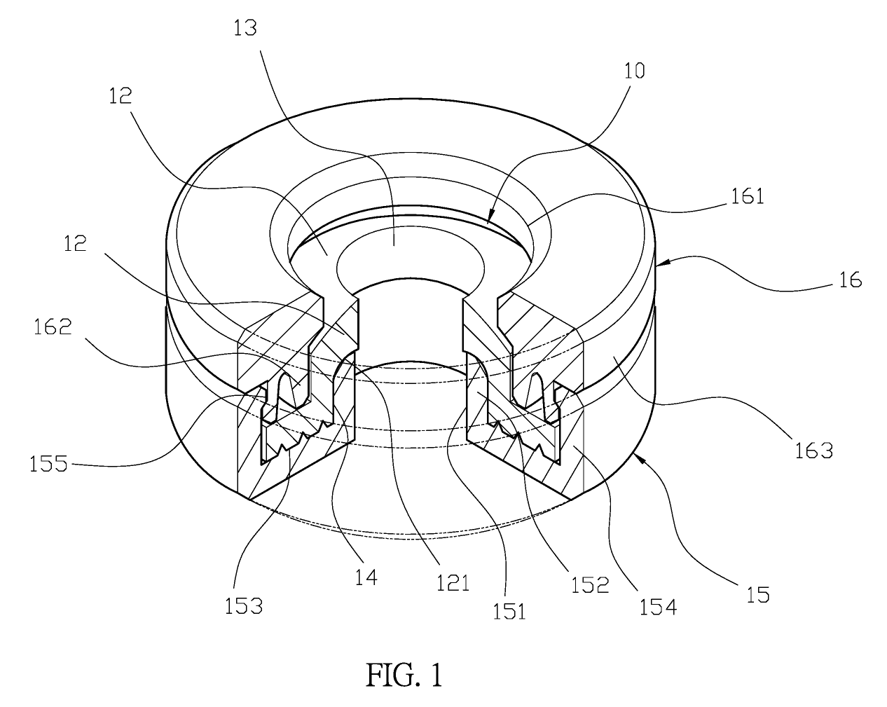

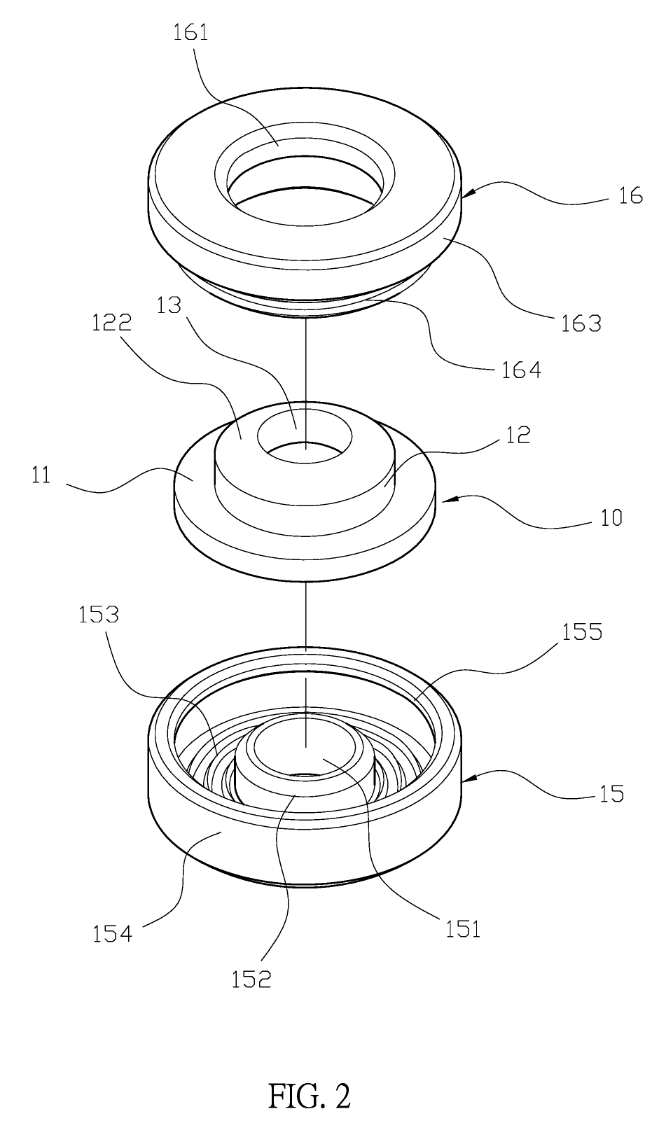

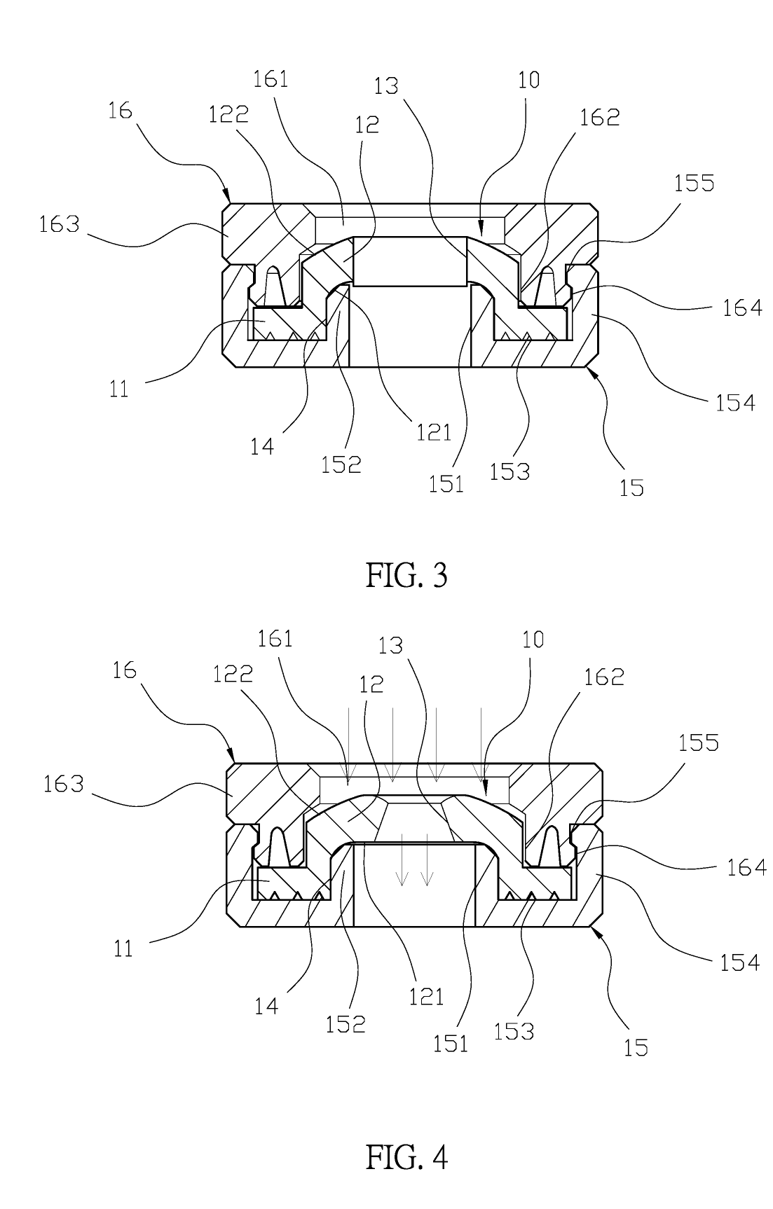

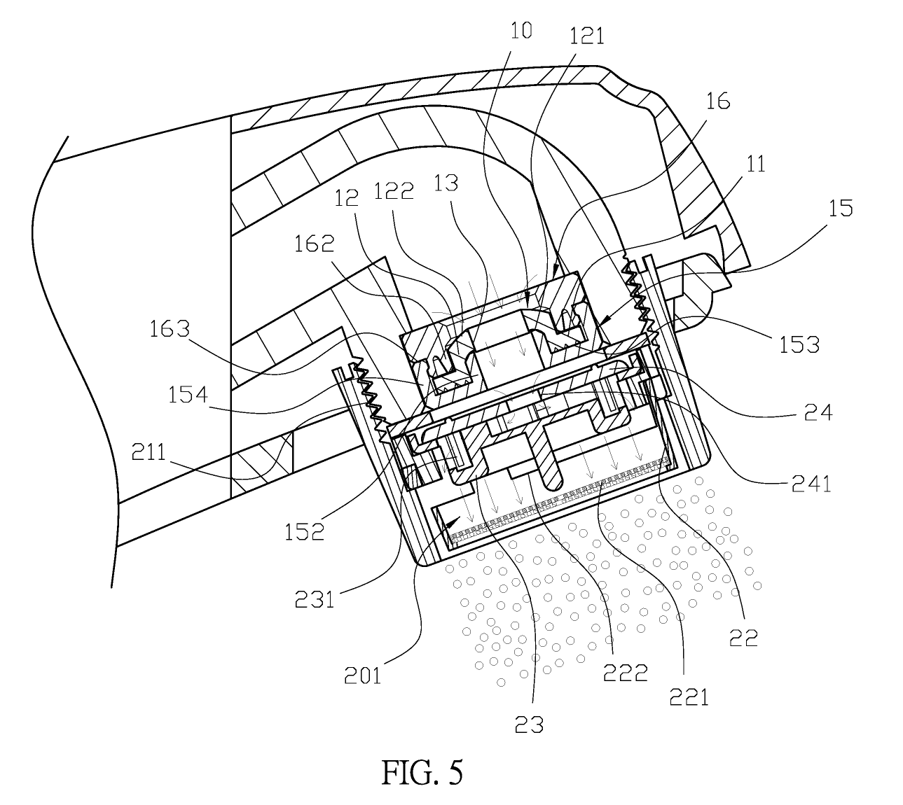

Please refer to FIG. 1, FIG. 2, FIG. 3 and FIG. 4. A water saving washer 10 is made of an elastic rubber material and has a circular flat shape with a flange 11 on its circumference. The water washer 10 has a flow adjustable portion 12 with an inner curved face 121 and an outer curved face 122. An adjustable inlet aperture 13 is disposed through the inner curved face 121 and the outer curved face 122 of the flow adjustable portion 12. When the water saving washer 10 is assembled to any water pipe (for example, the faucet or shower . . . etc.), the flow adjustable portion 12 of the water saving washer 10 faces coming water flow. When the water pressure is low, the adjustable inlet aperture 13 of the water saving washer 10 produces throttling effect to control the amount of water. When the water pressure is increased, the water pressure generates a pushing force onto the water saving washer 10. Meanwhile, the flow adjustable portion 12 of the water saving washer 10 is suffered from elastic deformation, the inner curved face 121 and the outer curved face 122 of the flow adjustable portion 12 control the amount of compression deformation. When the water pressure is high, the flow adjustable portion 12 recesses in a larger magnitude which narrows the adjustable inlet aperture 13. Furthermore, a supporting aperture 14 is provided between the flange 11 and the inner curved face 121, and the supporting aperture 14 is connected to the adjustable inlet aperture 13. The supporting aperture 14 supports the flow adjustable portion 12 and controls its elastic deformation, which also prevents the flow adjustable portion 12 from flipping over around. Therefore, under high water pressure, the water saving washer 10 stabilizes the elastic deformation of narrowing the adjustable inlet aperture 13, such that the water flow is not affected by water pressure.

For another embodiment of the present invention, please refer to FIG. 1 to FIG. 4. The water washer 10 has a flow adjustable portion 12 with an inner curved face 121 and an outer curved face 122. An adjustable inlet aperture 13 is disposed through the inner curved face 121 and the outer curved face 122 of the flow adjustable portion 12. A base 15 has a though hole 151 disposed at a center position and a supporting ring 152 disposed around the through hole 151. A bottom face 153 is formed outside of the supporting ring 152 and an outer ring 154 is disposed at an outer edge of the bottom face 153. A cover 16 has a through aperture 161 disposed at a center position, and a positioning ring 162 and a compressing loop 163 coaxially and sequentially disposed around the through aperture 161. The cover 16 engages with the base 15 to sandwich the water saving washer 10, the positioning ring 162 of the cover 16 presses against the flange 11 of the water saving washer 10, and the compressing loop 163 presses against the outer ring 154 of the base 15. Therefore, the base 15 and the cover 16 are able to secure the water saving washer 10. An inner engaging part 155 is provided in the outer ring 154 of the base 15, an outer engaging part 164 is provided on the positioning ring 162 of the cover 16, and the inner engaging part 155 and the outer engaging part 164 engages with each other. Therefore,

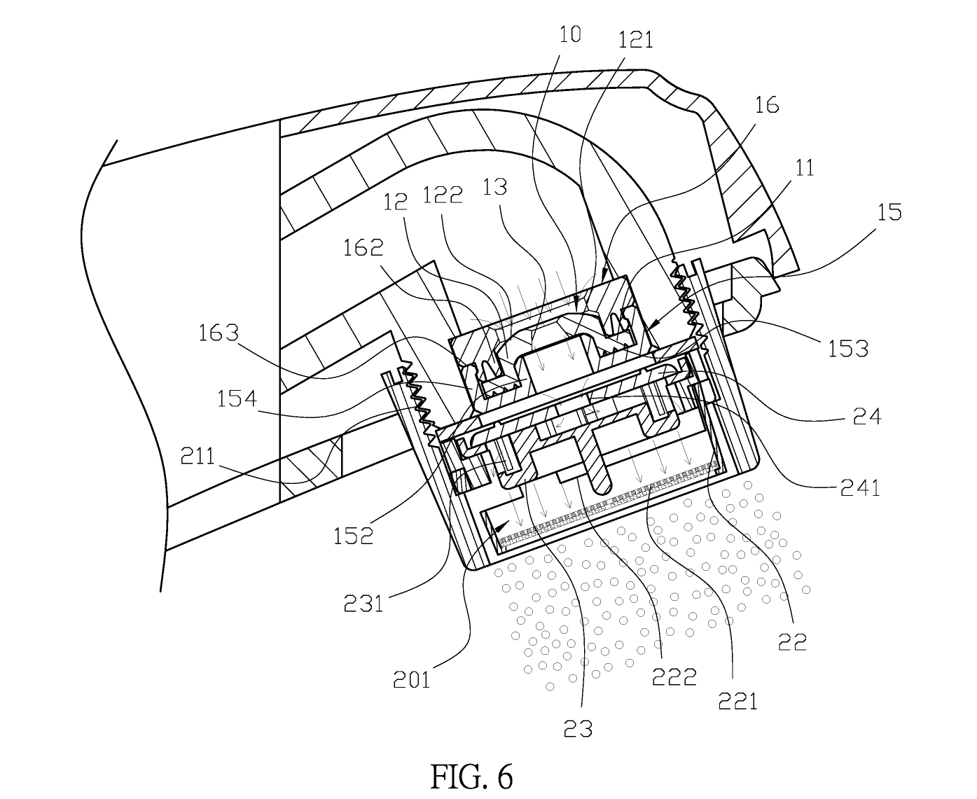

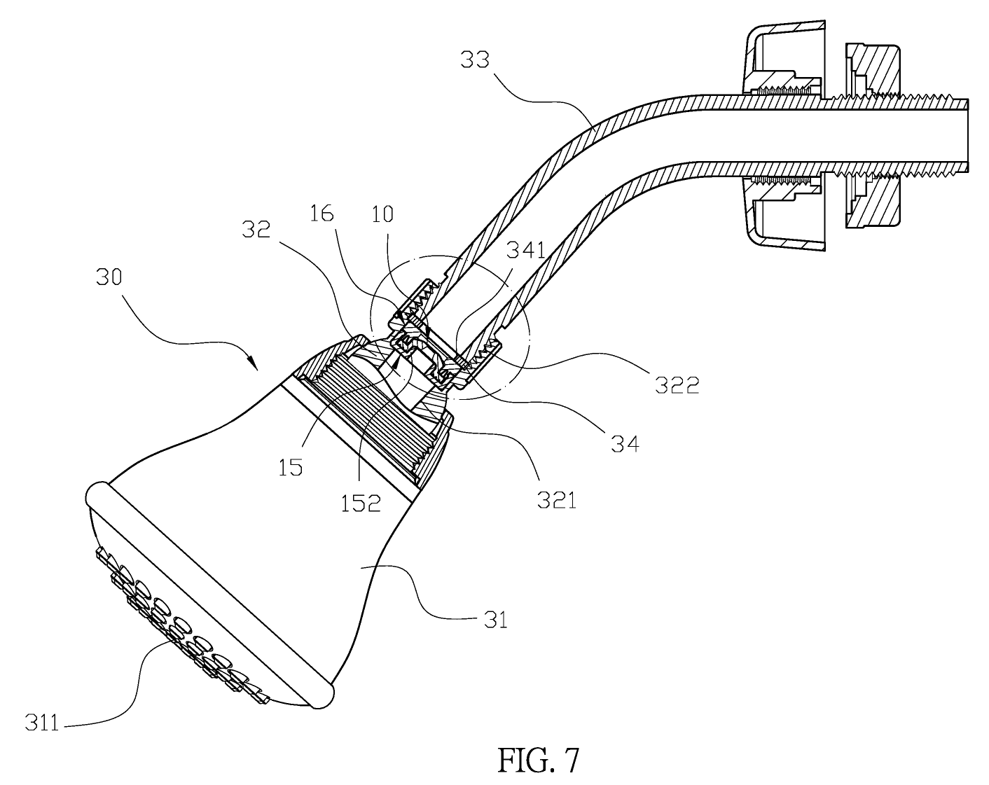

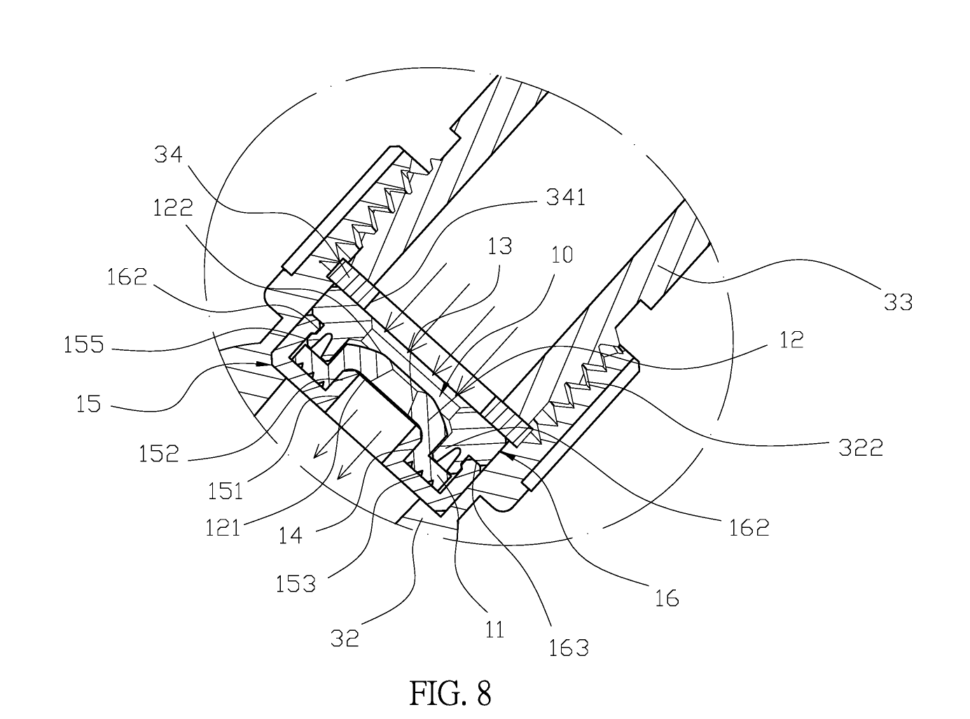

For another embodiment of the present invention, please refer to FIG. 6, FIG. 7 and FIG. 8. The water saving washer 10 is configured for an aerator 20. The aerator 20 comprises a casing 21, an aerator member 22, a filling member 23 and a restricting member 24. The aerator member 22, the filling member 23 and the restricting member 24 are placed in the casing 21, and the water saving washer 10 pushes against the restricting member 24. The restricting member 24 further has a limiting aperture 241 corresponding to the adjustable inlet aperture 121 of the water saving washer 10, and the filling member 23 is connected to the limiting aperture 241 and has a plurality of filling apertures 231. The aerator member 22 has a plurality of mesh members 221, a space 201 is formed between the mesh member 221 and the filling member 23, and the aerator member 22 further has a plurality of air apertures 222 around the space 201. Moreover, an inner thread section 211 is provided on the casing 21, the inner thread section 211 engages with the outlet pipe 25 of the faucet, and the flange 11 of the water saving washer 10 is sandwiched between the aerator 20 and the outlet pipe 25. When water flows from the outlet pipe 25 into the adjustable inlet aperture 13 of the water saving washer 10, the edge of the supporting aperture 14 of the water saving washer 10 presses against the restricting member 24 to prevent the water saving washer 10 from deformation. When water pressure is increased, the inner curved face 121 and the outer curved face 122 of the flow adjustable portion 12 of the water saving washer 10 provide elastic deformation to narrow the adjustable inlet aperture 13, which can efficiently control water flow. Afterward, water flows from the water saving washer 10 into the limiting aperture 241 of the restricting member 24, then from the limiting aperture 241 enters into the filling aperture 231 of the filling member 23 to mix with air provided by the air aperture 222 of the aerator member 22 in the space 201 and flushes onto the mesh member 221 of the aerator member 22 to add more air and pressure. Therefore, the water saving washer 10 can be combine with the current aerator 20 to satisfy the new regulations without the need of using a another sealing ring or changing to a new aerator 20.

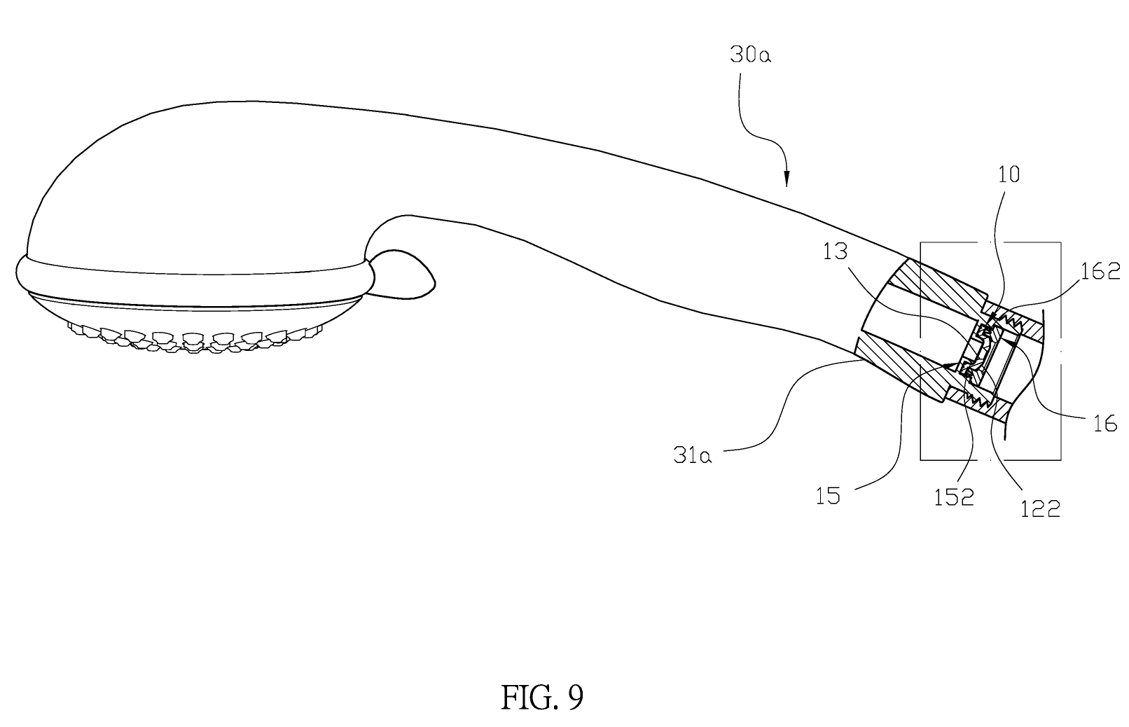

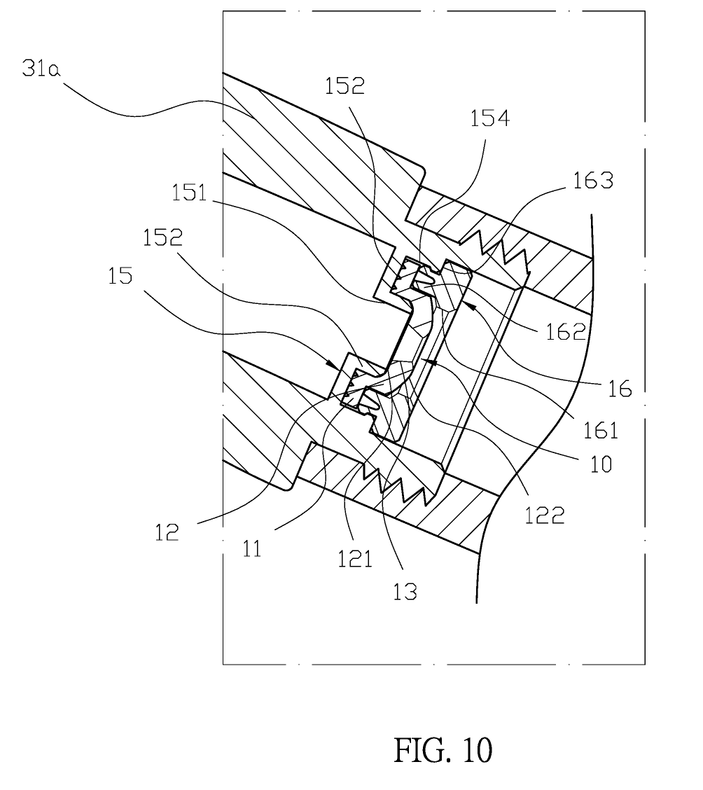

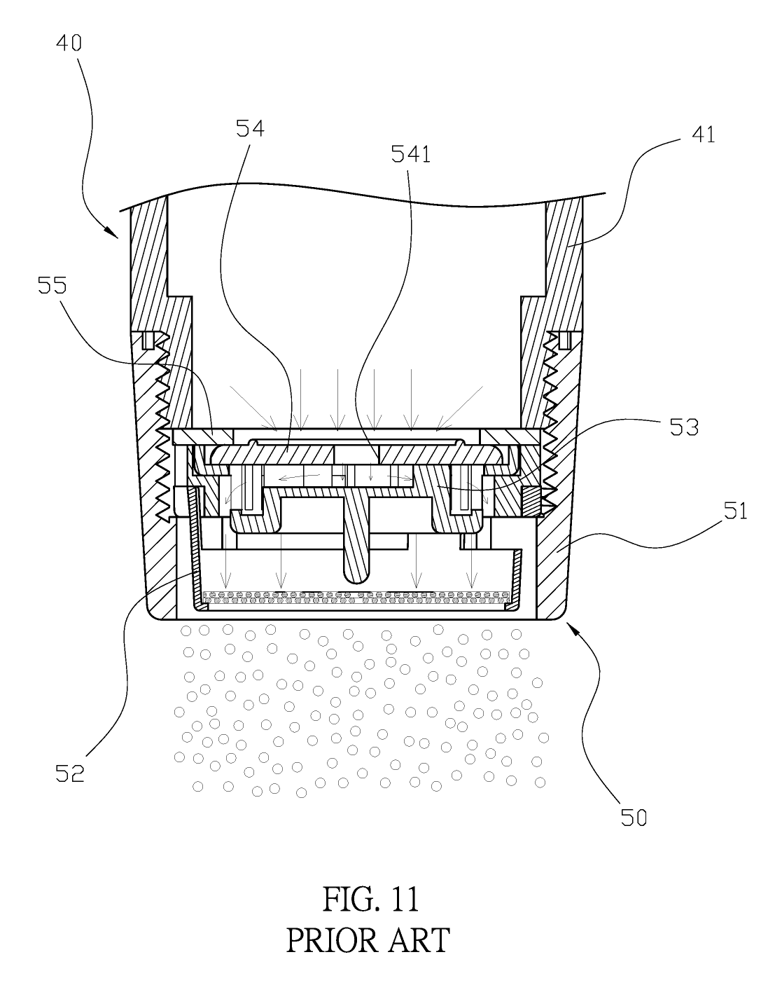

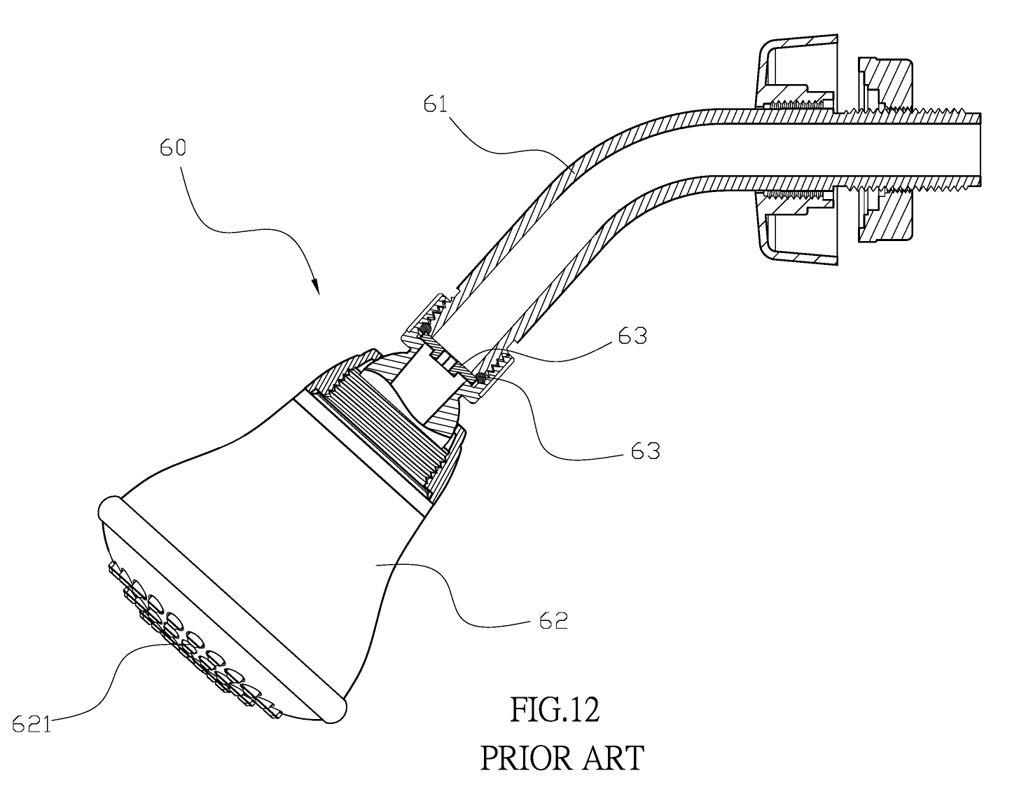

For another embodiment of the present invention, please refer to FIG. 9, and FIG. 10. The water saving washer 10 is configured for a shower head 30. The shower head 30 comprises a outlet head 31, a universal joint 32 and an outlet pipe 33. The outlet head 31 has a plurality of sprinkle apertures 311, the universal joint 32 is connected to another end of the outlet head 31 and has a water channel 321 connected to the sprinkle apertures 311. The universal joint 32 is further provided with an inner threaded portion 322 locked with the outlet pipe 33, and the flange 11 of the water saving washer 10 is sandwiched between the universal joint 32 and the outlet pipe 33. The flow adjustable portion 12 of the water saving washer 10 faces the outlet pipe 33, another side of the water saving washer 10 is provided with a securing plate 34 having a flowing aperture 341, and the flowing aperture 341 is connected to the adjustable inlet aperture 13 of the water saving washer 10. The securing plate 34 enhances the strength of the water saving washer 10. When water flows from the outlet pipe 33 into the adjustable inlet aperture 13 of the water saving washer 10, the edge of the supporting aperture 14 of the water saving washer 10 presses against the securing plate 34 to prevent the water saving washer 10 from deformation.

When water pressure is increased, the inner curved face 121 and the outer curved face 122 of the flow adjustable portion 12 of the water saving washer 10 provide elastic deformation to narrow the adjustable inlet aperture 13, which can efficiently control water flow. When water flows from the water saving washer 10 into flowing aperture 341 of the securing plate 34 and the water channel 321 of the universal joint 32. Afterward, water flows out of the sprinkle apertures 311 of outlet head 31. Therefore, the water saving washer 10 can be combine with the current shower head 30 to satisfy the new regulations without the need of using a another sealing ring or changing to a new shower head 30.

Although the present invention has been explained in relation to its preferred embodiment, it is to be understood that many other possible modifications and variations can be made without departing from the spirit and scope of the invention as hereinafter claimed.

What is claimed is:

1. A water saving washer with an adjustable inlet aperture for different water pressure comprising:
the water saving washer made of an elastic rubber material and has a circular flat shape with a flange on its circumference; a flow adjustable portion has a flow adjustable portion with an inner curved face and an outer curved face; an adjustable inlet aperture is disposed through the inner curved face and the outer curved face of the flow adjustable portion; by deforming the inner curved face and the outer curved face of the flow adjustable portion to shirk the adjustable inlet aperture of the water saving washer;
a base having a though hole disposed at a center position and a supporting ring disposed around the through hole, a bottom face formed outside of the supporting ring and an outer ring disposed at an outer edge of the bottom face; and
a cover having a through aperture disposed at a center position, a positioning ring and a compressing loop coaxially and sequentially disposed around the through aperture, the cover engaging with the base to sandwich the water saving washer, the positioning ring of the cover pressing against the flange of the water saving washer, and the compressing loop pressing against the outer ring.

2. The washer with an adjustable inlet aperture for different water pressure as claimed in claim 1, wherein the water saving washer is configured for an aerator, the aerator comprises a casing, an aerator member, a filling member and a restricting member, the aerator member, the filling member and the restricting member are placed in the cover, and the water saving washer pushes against the restricting member.

3. The washer with an adjustable inlet aperture for different water pressure as claimed in claim 2, wherein the restricting member further has a limiting aperture corresponding to the adjustable inlet aperture of the water saving washer, and the filling member is connected to the limiting aperture and has a plurality of filling apertures; the aerator member has a plurality of mesh members, a space is formed between the mesh member and the filling member, and the aerator member further has a plurality of air apertures around the space.

4. The washer with an adjustable inlet aperture for different water pressure as claimed in claim 3, wherein an inner thread section is provided on the cover, the inner thread section engages with the outlet pipe of the faucet, and the base and the cover are sandwiched between the aerator and the outlet pipe.

5. The washer with an adjustable inlet aperture for different water pressure as claimed in claim 1, wherein the water saving washer is configured for a shower head, the shower head comprises an outlet head, a universal joint and an outlet pipe; the outlet head has a plurality of sprinkle apertures; the universal joint is connected to another end of the outlet head and has a water channel connected to the sprinkle apertures; the universal joint is further provided with an inner threaded portion locked with the outlet pipe, base and the cover are sandwiched between the universal joint and the outlet pipe.

6. The washer with an adjustable inlet aperture for different water pressure as claimed in claim 5, wherein the flow adjustable portion of the water saving washer faces the outlet pipe, a surface of the cover is provided with a securing plate having a flowing aperture, and the flowing aperture is connected to the adjustable inlet aperture of the water saving washer.

7. The washer with an adjustable inlet aperture for different water pressure as claimed in claim 5, wherein the base and the outlet head are integratedly formed together, and the water saving washer and the cover are sequentially placed in the outer head and secured onto the base.

8. The washer with an adjustable inlet aperture for different water pressure as claimed in claim 1, wherein an inner engaging part is provided in the outer ring of the base, an outer engaging part is provided on the positioning ring of the cover, and the inner engaging part and the outer engaging part engages with each other.
